(19) United States
(12) Patent Application Publication
(10) Pub. No.: US 2011/0173668 A1
(43) Pub. Date: Jul. 14, 2011

(54) SYSTEM AND METHOD FOR CONTROLLING HOME DEVICES VIA A SET TOP BOX

(75) Inventors: Kelsyn Rooks, Overland Park, KS (US); David Emerson, Overland Park, KS (US); Gary Lafreniere, Olathe, KS (US)

(73) Assignee: EMBARQ HOLDINGS COMPANY, LLC

(21) Appl. No.: 12/684,549

(22) Filed: Jan. 8, 2010

(51) Int. Cl. H04N 7/18

(52) U.S. Cl. 725/80; 725/85

(57) ABSTRACT

Embodiments of the disclosed invention include an apparatus, method, and computer program product for interacting and/or controlling one or more home devices through a set top box using data received from one or more user-specified internet sources. For example, in one embodiment, the set top box may be configured to alter a home lighting system, a home audio system, a home heating and air conditioning system, based on data received through the set top box. In other embodiments, the set top box may be configured to display data from one or more user-specified internet sources (e.g., updates to a fantasy football score) on a television for enabling a user to view the updated information while watching a television program.

### BACKGROUND OF THE INVENTION

A set-top box (STB) or set-top unit (STU) is a device that connects to a television and an external source for receiving a signal. The set top box turns the signal into audio and video content which is then transmitted to a television set. In IPTV (Internet Protocol television) networks, the set-top box is a small computer providing two-way communications on an IP network and decoding the video streaming media. IP set-top boxes have a built in home network interface which can be Ethernet or one of the existing wire home networking technologies such as HomePNA or the ITU-T G.hn standard, which provides a way to create a high-speed (up to 1 Gigabit/s) Local area network using existing home wiring (power lines, phone lines, and coaxial cables).

### SUMMARY

Embodiments of the disclosed invention include an apparatus, method, and computer program product for controlling home devices via a set top box. In one embodiment, the method comprises configuring a set top box to communicate with a home device. A home device as referenced herein is an electronic device located in the same building as the set top box. The method includes receiving, at the set top box, data over a network connection. The method determines based on the data whether to generate and transmit a command to the home device for performing a particular action.

In another embodiment, a method for displaying information on a television is disclosed. The method comprises receiving, at a set top box, data from a user-specified internet source. The method generates a display interface for displaying the content of the data on at least one television communicatively coupled to the set top box.

Still, in another embodiment, a set top box is disclosed for communicating data to one or more home devices. The set top box comprises a communication interface for receiving media content from a content provider. The communication interface further configured to communicate with one or more home devices. An input/output interface is used to distribute the media content to a display device. The set top box includes a memory component for storing computer executable instructions; a processing unit for executing the computer executable instructions to: receive data over a network connection, determine which home device from a plurality of home devices to communicate with based on the content of the data, and communicate with the determined home device to perform an action based on the received data.

### BRIEF DESCRIPTION OF THE DRAWINGS

Illustrative embodiments of the present invention are described in detail below with reference to the attached figures, which are incorporated by reference herein and wherein:

FIG. 1 depicts an embodiment of a network environment in which the illustrative embodiments may be implemented;

FIG. 2 illustrates a conceptual block diagram of a set top box in accordance with certain embodiments of the invention;

FIG. 3 illustrates an embodiment of a process for controlling home devices through a set top box in accordance with certain embodiments of the invention;

FIG. 4 illustrates an embodiment of a process for displaying information on a television via a set top box in accordance with certain embodiments of the invention; and

FIGS. 5A-5C illustrates several embodiments of a television displaying information from a user-specified internet source in accordance with certain embodiments of the invention.

### DETAILED DESCRIPTION

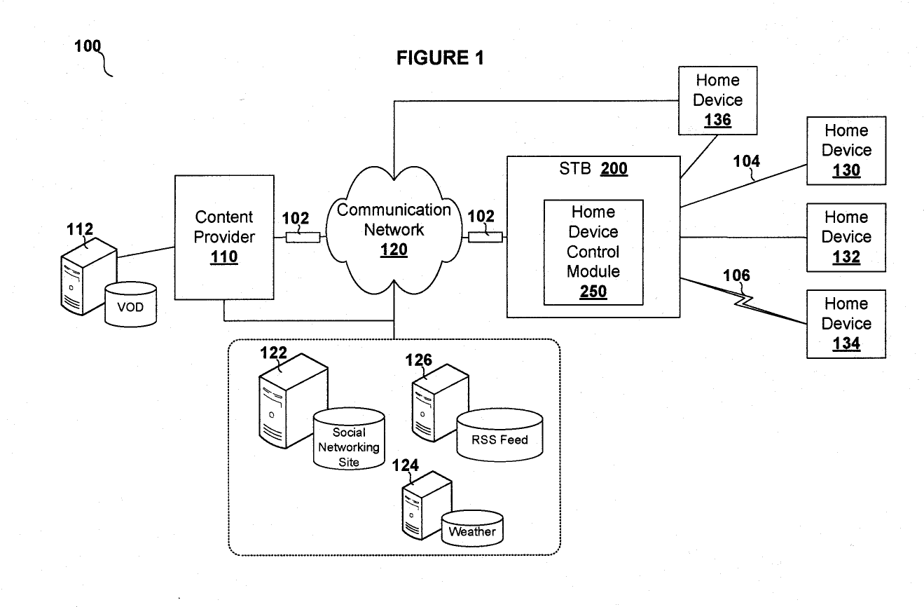

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which the illustrative embodiments may be implemented. In the depicted embodiment, a content provider 110 transmits media content 102 to a set top box 200 via communication network 120. Content provider 110 may be, but is not limited to, a cable, satellite, Internet Protocol Television (IPTV)/Internet television provider, and/or an Internet service provider. In some embodiments, content provider 110 may include one or more cable head ends for distributing media content to subscribers. In addition, content provider 110 may include and/or communicate with one or more data processing systems, such as, but not limited to, a video on demand database system 112 for providing media content.

In some embodiments, communication network 120 may include, but is not limited to, one or more coaxial cable networks, fiber-optic networks, and/or satellite networks. In addition, in certain embodiments, communication network 120 may also include twisted pair networks and/or one or more IP networks, such as, but not limited to, the Internet, for providing IPTV/Internet cable television-type services and/or other related services.

Media content 102 may include audio and video content, such as, but not limited to, a television program. In some embodiments, media content 102 may include other information associated with the transmitted audio and video content, such as, but not limited to, an electronic programming guide. In addition, in accordance with certain of the disclosed embodiments, media content 102 may include any type of data, such as, but not limited to, data received from one or more user-specified internet sources, such as, but not limited to, a social networking site 122 (e.g., Facebook®, Twitter®, and/or MySpace®), a user-subscribe RSS (Really Simple Syndication) feed 126, and/or any other internet source/site 124 (e.g., a weather information source and/or a fantasy football/sports site). As will be further described, set top box 200 may utilize data 102 to interacting with and/or controlling one or more home devices.

Set top box 200 may be any type of device capable of distributing media content 102 to one or more display devices. Set top box 200 may include one or more components for decoding media content 102. For example, as will be further described, in some embodiments, set top box 200 may include one or more cable tuners for decoding media content 102 and for providing the decoded media content to one or more display devices, such as, but not limited to, a television set.

In accordance with certain embodiments, set top box 200 may include a home control module 250 and other components for interacting with and/or controlling one or more home devices, such as, but not limited to, home devices 132-136. Home devices 132-136 may include, but are not limited to, a television, a home audio system, a home lighting system, a home heating and air conditioning control system, a home phone system, and a home irrigation control system. In certain embodiments, set top box 200 may utilize data receive from one or more sources (e.g., 122-126) for performing an action associated with one or more of the home devices 132-136. For example, in one embodiment, set top box 200 may utilize weather information received from internet source/site 124 for generating a command to a home irrigation control system to enable or disable and/or reschedule watering of a home's premises, and/or to a home heating and air conditioning control system for automatically adjusting the temperature within a home. In another embodiment, set top box 200 may utilize information received from user-specified internet source/site 124 (e.g., fantasy football updates and/or a social website update) to generate a display interface for displaying the content of the data on at least one television associated with set top box 200. In some embodiments, set top box 200 may be configured to automatically receive updates as they occur or, alternatively, set top box 200 may be configured to periodically check for updates from one or more user-specified sources.

In certain embodiments, set top box 200 may communicate with a home device using wired 104 or wireless 106 communication links. For example, set top box 200 may be physically coupled to a home device, such as, but not limited to, a television, via one or more video/audio cable wires. In addition, in some embodiments, set top box 200 may include one or more wireless transmitters and/or transceivers that utilize wireless communication technology, such as, but not limited to, RF (radio frequency), IR (infrared), Bluetooth, WiFi, and ZWave, for interacting and/or controlling one or more home devices. For example, in one embodiment, set top box 200 may be wirelessly configured to communicate with a home lighting system using RF or IR signals for automatically adjusting the lighting in a portion of the home near set top box 200 in response to receiving media content following a user's request for a video on demand. Alternatively, in some embodiments, set top box 200 may communicate with a home device (e.g., home device 136) over communication network 120. For example, in one embodiment, home device 136 may be a home IP phone system. Set top box 200 may be configured to automatically transmit a command to home device 136 over communication network 120 to either raise or lower the ringer volume in response to receiving media content following a user's request for a video on demand and/or at any other user requested time.

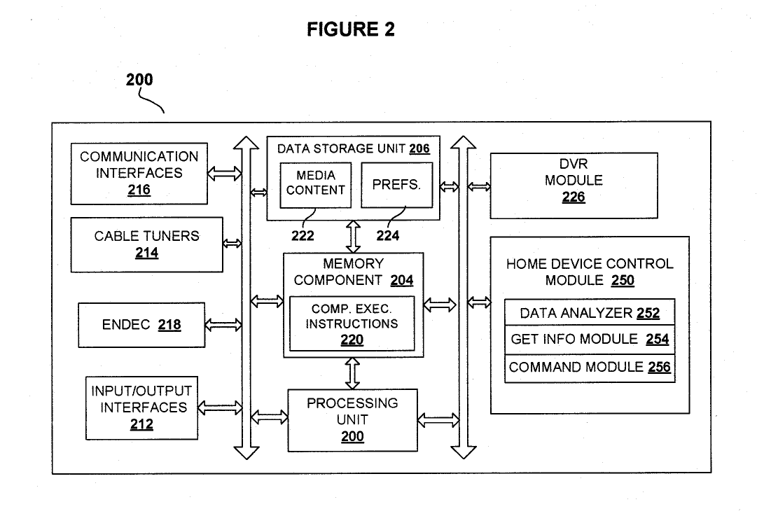

FIG. 2 illustrates an embodiment of set top box 200 in accordance with certain embodiments of the invention. In the depicted embodiment, set top box 200 comprises, among other components, a processing unit 200, a memory component 204, a data storage unit 206, and a set of communication interfaces 216.

Processing unit 200 may comprise of one or more microprocessors for executing computer usable program code/instructions for interacting and/or controller one or more home devices using data received over communication network 120. For example, in one embodiment, processing unit 200 executes computer executable instructions 220 stored in memory component 204 for retrieving updates from a user-specified website and displaying that information on a television associated with set top box 200 while enabling a user to continue viewing a television program.

Data storage unit 206 may be any type of non-volatile memory, such as, but not limited to, one or more hard disk drives. In some embodiments, data storage unit 206 may be an external hard drive and/or flash memory, such as, but not limited to, an SD (Secure Digital) card, or USB flash drive. Data storage unit 206 may be utilized to store recorded media content 222 for later playback. In addition, in some embodiments, data storage unit 206 may store user preferences/user configuration settings 224. For example, user preferences 224 may contain user-specified internet addresses, usernames, passwords, data display configurations (e.g., whether to display updates, when to check for updates, etc.), lighting configurations, audio configurations, and any other settings associated with set top box 200 controlling and/or interacting with one or more of the home devices 132-136.

In accordance with the disclosed embodiments, set top box 200 includes a set of communication interfaces 216 for receiving media content 102 from content provider 110. In some embodiments, communication interfaces 216 may include, but is not limited to, a coaxial cable connection, an Ethernet port, and/or a telephone line interface for connecting set top box 200 to communication network 120. In addition, communication interfaces 216 may be utilize to receive, retrieve, and/or request data from one or more user-specified internet sources (e.g., 122-126). Additionally, in some embodiments, communication interfaces 216 may be utilize to communicate with one or more home devices via communication network 120, a direct wired connection, and/or via a wireless communication link. For example, as described above, in some embodiments, communication interfaces 216 may include one or more wireless transmitters and/or transceivers that utilize wireless communication technology, such as, but not limited to, RF (radio frequency), IR (infrared), Bluetooth, WiFi, and ZWave, for interacting and/or controlling one or more home devices.

In addition, set top box 200 may include a set of input/output interfaces 212 for connecting set top box 200 to one or more display devices. For example, in one embodiment, input/output interfaces 212 may include, but is not limited to, one or more coaxial cable connections, audio/video components connections, digital visual interfaces (DVI), S-video connections, composite video connections, and/or high-definition multimedia interfaces (HDMI). Additionally, in some embodiments, input/output interfaces 212 may include other data communication interfaces, such as, but not limited to, a 1394 interface and/or a universal serial bus (USB) interface. Set top box 200 may include other components, such as, but not limited to, one or more cable tuners 214 for receiving and extracting the contents of media content 102 and one or more encoders/decoders (EnDecs) 218 for encoding/decoding data packets into one or more formats. In certain embodiments, set top box 200 may include a digital video recorder (DVR) module 226 for managing the recording of media content and for playback of stored media content files 222.

As stated above, in accordance with one embodiment, set top box 200 includes home control module 250 for interacting with and/or controlling one or more home devices using data received over communication network 120. In one embodiment, home control module 250 may include one or more sub-modules, such as, but not limited to, data analyzer module 252, get info module 254, and a command module 256. Home control module 250 and the depicted sub-modules may include executable instructions and/or specific hardware components for performing one or more tasks. For instance, in one embodiment, home control module 250 may include executable instructions for enabling a user to specify an internet source to receive content/data from for displaying the content in a viewing area of a television while the user watches a television program and/or for interacting/controlling another home device based on the received data. For example, in one embodiment, in response to receiving data, home control module 250 passes the data to data analyzer module 252 for determining an action to perform based on the received data. Data analyzer module 252 may utilize the data type, the data source, the data encoding scheme, and/or any other information associated with the data for identifying and analyzing the data. In one embodiment, if data analyzer module 252 determines that the data is an update from a user-specified internet source (e.g., a social networking website and/or a fantasy football website), data analyzer module 252 passes the data to a particular function of command module 256 for generating a display interface for displaying content from the data on at least one television associated with set top box 200. In another embodiment, if data analyzer module 252 determines that the data is weather information (e.g., current temperature, forecast temperature, rainy conditions, etc.), data analyzer module 252 may pass the weather information to a particular function of command module 256 for generating a command to instruct a home heating and air conditioning control system to increase or decrease a home temperature setting and/or for generating a command to instruct a home irrigation control system to alter a watering schedule. In some embodiments, the generated command may be in the form of a wireless signal such as, but not limited to, a radio frequency signal or an infrared signal. Still, in some embodiments, if data analyzer module 252 determines that the data is media content received in response to a video on demand request, command module 256 may be configured to generate a command to a home lighting system to lower the intensity of lights within a predetermined area around a television displaying the media content. Similarly, in some embodiments, if data analyzer module 252 determines that the data is media content received in response to a video on demand request, command module 256 may be configured to generate and transmit a command to increase the volume intensity of a television and/or a home audio system (e.g., a surround sound system).

In certain embodiments, home control module 250 utilizes get info module 254 for monitoring and retrieving updates from the one or more user-specified internet sources/sites. In some embodiments, get info module 254 only monitors and retrieves updates while a user is viewing a television associated with set top box 200. In other embodiments, a user may configure get info module 254 to retrieve updates and store the updates locally in data storage unit 206 and display the stored updates once a television associated with set top box 200 is powered on. In addition, in some embodiments, get info module 254 may be configured to retrieve information for enabling communication with one or more home devices. For example, in one embodiment, get info module 254 may download from a remote source (e.g., a manufacturer's website and/or third party database) frequency codes (e.g., infrared and/or radio frequency) for communicating and controlling a particular home device.

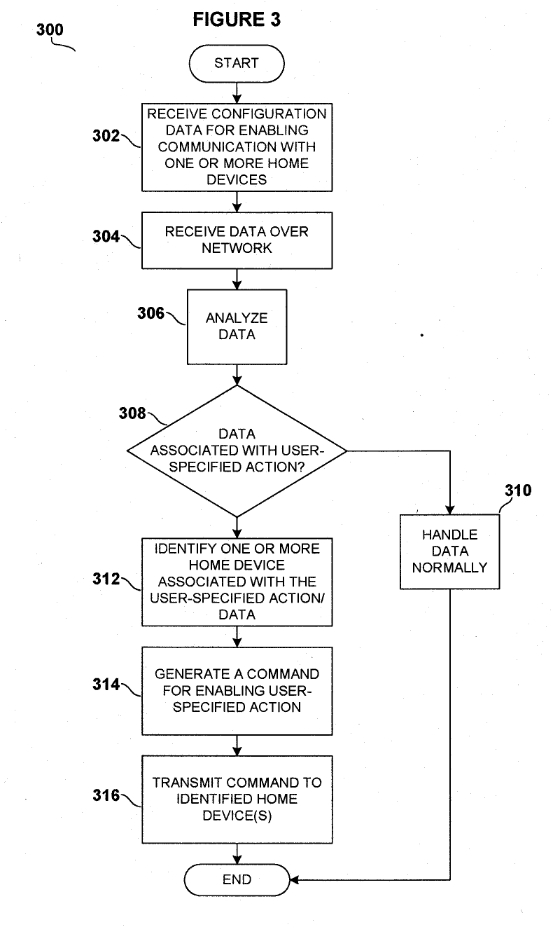

FIG. 3 illustrates an embodiment of a process 300 for controlling home devices via set top box 200 in accordance with certain embodiments of the invention. In the depicted embodiment, process 300 begins by receiving configuration data for enabling communication with one or more home devices at step 302. The configuration data may include communication frequency codes, actions to perform in response to received data, data parameters, and/or any other information necessary for interacting and/or controlling a home device. In certain embodiments, the configuration data may be manually entered by a user of set top box 200. Alternatively, and/or in addition to, in some embodiments, part or all of the configuration data may be retrieved from one or more remote sources. At step 304, the process receives data over the network. The process analyzes the data at step 306 to determine an action to perform based on the received data (step 308). If the process determines that the received data is not associated with any particular action (e.g., the data is normal media content or an electronic programming guide), the process handles the data as it normally would at step 310, with process 300 terminating thereafter.

However, if the process determines that the data is associated with a user-specified action, the process identifies one or more home devices associated with the determined user-specified action at step 312. At step 314, the process generates a command for performing the user-specified action and transmits the command to the identified home device(s) at step 316, with process 300 terminating thereafter.

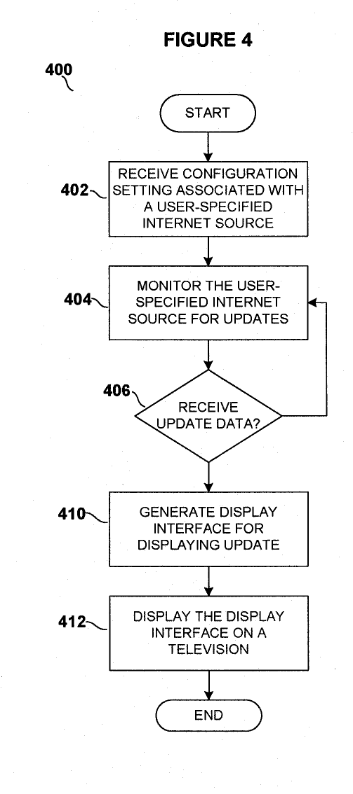

FIG. 4 illustrates an embodiment of a process 400 for displaying information on a television via set top box 200 in accordance with certain embodiments of the invention. In the depicted embodiment, process 300 begins by receiving configuration data associated with one or more user-specified internet sources. The configuration data may include one or more user-specified internet sources/sites (e.g., IP address), usernames, passwords, communication protocols, and/or any other information necessary for retrieving information from a user-specified internet source. The process monitors the user-specified internet sources for updates at step 404. At step 406, the process determines whether it receives updated information from the one or more user-specified internet sources. In response to receiving updated information from the one or more user-specified internet sources, the process generates a display interface for displaying the content of the updated information at step 410. The process displays the display interface containing the updated information on a television associated with set top box 200, with process 400 terminating thereafter. Accordingly, a user is able to view updated information from one or more user-specified internet sources while watching a television program.

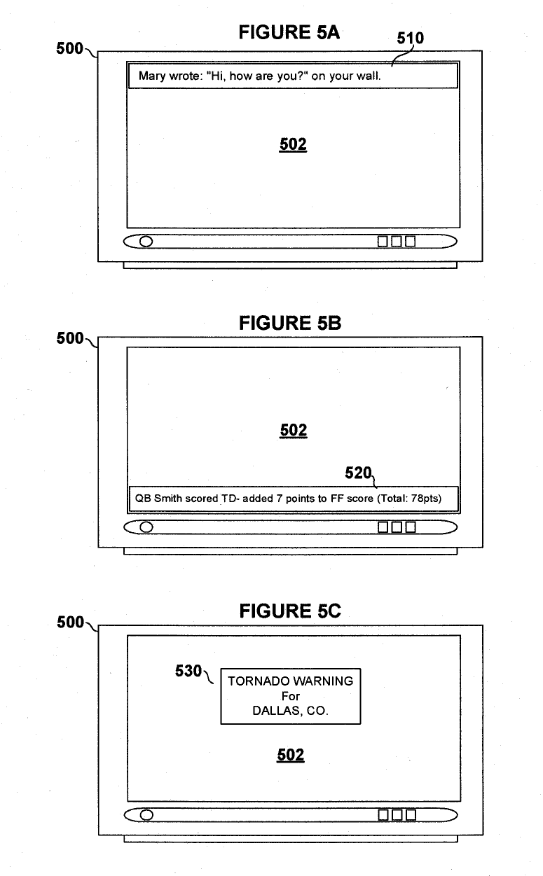

For example, FIGS. 5A-5C illustrates several embodiments of a television set displaying information from a user-specified internet source in accordance with certain embodiments of the invention. For instance, FIG. 5A illustrates an embodiment in which updated information 510 from a social networking website may be displayed on a television set for enabling a user to view a television program and monitor updates on a social networking website at the same time. Alternatively, a user may configure set top box 200 to receive an RSS news feed for receiving the latest news stories. In one embodiment, the updated information area may contain scrolling text for notifying a user of updated information. The notification area may be located at any portion of a television screen. For example, FIG. 5B illustrates a notification area 520 at the bottom of the screen for notifying a user of updates to his fantasy football score. In some embodiments, the notification area may be semi-transparent for enabling a user to view a show in the background. In other embodiments, the notification area may be separated from a television program viewing area 502. In addition, in some embodiments, set top box 200 may be configured to identify to monitor an internet source for emergency alerts affecting an area associated with the user and notify the user of an emergency alert 530 as indicated in FIG. 5C. Further, in some embodiments, set top box 200 may display the updated information even when the user is viewing a non-live broadcast (e.g., a recorded program, a DVD, etc.) for enabling a user to receive the desired updates and emergency alerts from the one or more user-specified internet sources.

The above disclosure describes several embodiments including a system and method for interacting and/or controlling one or more home devices through a set top box using data received from one or more remote sources. The above disclosure merely describes certain embodiments of the claimed invention and is not intended to limit the scope of the claimed invention. In addition, the disclosed embodiments are described above with reference to flowchart illustrations, sequence diagrams, and/or block diagrams. Each block of the flowchart illustrations and/or block diagrams, and combinations of blocks in the flowchart illustrations and/or block diagrams, may be implemented by computer program instructions, hardware components, and/or any combination thereof. In addition, the flowchart and block diagrams in the figures illustrate the architecture, functionality, and operation of possible implementations of systems, methods and computer program products according to various embodiments of the claimed invention. In this regard, each block in the flowchart or block diagrams may represent a module, segment, or portion of code, which may include one or more executable instructions for implementing the specified logical function(s). In some alternative implementations, the functions noted in the block may occur out of the order noted in the figures and/or may be omitted. In addition, two blocks shown in succession may, in fact, be executed substantially concurrently, or the blocks may sometimes be executed in the reverse order, depending upon the functionality involved.

Additionally, computer program instructions for executing the disclosed embodiments may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a data processing apparatus to cause a series of operational steps to be performed on the data processing system to produce a computer implemented process such that the instructions which execute on the data processing system provide processes for implementing the functions/acts specified in the flowchart and/or block diagram block or blocks.

The terminology used herein is for describing particular embodiments only and is not intended to be limiting of the invention. As used herein, the singular forms “a”, “an” and “the” are intended to include the plural forms as well, unless the context clearly indicates otherwise. In addition, as referenced herein, a module is defined as hardware, software, and/or a combination thereof for performing a particular function. Software is defined as computer executable instructions including, but not limited to, object code, assembly code, and machine code. Hardware may include, but is not limited to, one or more processors/microprocessors, electronic circuitry, and other physical components. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The disclosed embodiments were chosen to explain the principles of the invention and the practical application, and to enable others of ordinary skill in the art to understand the invention for various embodiments with various modifications as are suited to the particular use contemplated.

We claim:

1. A method for controlling home devices via a set top box, the method comprising:
configuring the set top box to communicate with a first home device;
receiving, at the set top box, data over a network connection;
determining based on the data whether to transmit a command to the first home device;
generating the command in response to a determination to transmit the command to the first home device based on the data, and
transmitting the command to the first home device.

2. The method of claim 1, further comprising;
configuring the set top box to communicate with a second home device;
determining based on the data whether to transmit the command to the first home device or the second home device; and
generating the command in response to a determination to transmit the command based on the data to the second home device; and
transmitting the command to the second home device.

3. The method of claim 1, wherein the set top box is configured to communicate with the first home device via a wireless interface.

4. The method of claim 1, wherein the first home device is a home lighting system, and the method further comprising:
determining that the data contains media content transmitted in response to a user request for a video on demand;
generating the command to lower the intensity of lights within a predetermined area of a display device displaying the media content; and
transmitting the command to the home lighting system.

5. The method of claim 1, wherein the first home device is a home audio system, and the method further comprising:
determining that the data contains media content transmitted in response to a user request for a video on demand;
generating the command to increase the volume intensity associated with a display device displaying the media content; and
transmitting the command to the home audio system.

6. The method of claim 1, wherein the first home device is an irrigation control system, and the method further comprising:
determining that the data contains weather information for a location associated with the set top box; and
determining based on the weather information whether to transmit the command to the irrigation control system, the command being one to enable or disable watering of a premise.

7. The method of claim 1, wherein the first home device is a home heating and air conditioning control system, and the method further comprising:
determining that the data contains weather information for a location associated with the set top box; and
determining based on the weather information whether to transmit the command to the home heating and air conditioning control system, the command being one to increase or decrease a temperature within a home.

8. The method of claim 1, wherein the first home device is a television, the data is from a user-specified internet source, and the command is to display an interface that contains content from the data on the television.

9. A method for displaying information on a television, the method comprising:
receiving, at a set top box, data from a user-specified internet source;
generating a display interface for displaying content associated with the data on a television communicatively coupled to the set top box; and
displaying the display interface on the television.

10. The method of claim 9, wherein the data is received from a user-specified RSS feed.

11. The method of claim 9, wherein the data contains an update received from a social networking site associated with a user of the set top box.

12. The method of claim 9, wherein the data contains emergency information for a location associated with a user of the set top box.

13. The method of claim 9, wherein the data contains an update received from a fantasy sports internet site associated with a user of the set top box.

14. A set top box comprising:
a communication interface for receiving media content from a content provider, the communication interface further configured to communicate with one or more home devices;
a memory component for storing computer executable instructions;
a processing unit for executing the computer executable instructions to:
receive data over a network connection;
determine based on content of the data which home device from a plurality of home devices to communicate with; and
communicate with the determined home device to perform an action based on the data.

15. The set top box of claim 14, wherein the data is received from a user-specified RSS feed and the action is displaying content from the user-specified RSS feed to a television associated with the set top box.

16. The set top box of claim 14, wherein the data is received from a social networking site associated with a user of the set top box and the action is displaying content from the data to a television while simultaneously displaying a television program on the television.

17. The set top box of claim 14, wherein the data contains emergency information for a location associated with a user of the set top box and the action is displaying to a television an emergency alert notification based on the data.

18. The set top box of claim 14, wherein the processing unit further executes the computer executable instructions to communicate with a home lighting system to change the intensity of lights within a predetermined area of the home in response to the data containing media content transmitted responsive to a video on demand request.

19. The set top box of claim 14, wherein the processing unit further executes the computer executable instructions to alter a volume on a display device in response to a determination that the data contains media content transmitted responsive to a video on demand request.

20. The set top box of claim 14, wherein the processing unit further executes the computer executable instructions to alter a ringer volume on a telephone device in response to a determination that the data contains media content transmitted responsive to a video on demand request.
